(19) United States
(12) Patent Application Publication
(10) Pub. No.: US 2021/0158380 A1
(43) Pub. Date: May 27, 2021

(54) CASH DEMAND PREDICTION SYSTEM, CASH DEMAND PREDICTION METHOD, AND CASH DEMAND PREDICTION PROGRAM

(71) Applicant: NEC CORPORATION, Tokyo (JP)

(72) Inventors: Takashi TOUKAIRIN, Tokyo (JP); Yousuke MOTOHASHI, Tokyo (JP); Keiji KANDA, Tokyo (JP); Akira TANIMOTO, Tokyo (JP)

(73) Assignee: NEC CORPORATION, Tokyo (JP)

(21) Appl. No.: 16/640,839

(22) PCT Filed: Jun. 27, 2018
(86) PCT No.: PCT/JP2018/024321

§ 371 Date: Feb. 21, 2020

(30) Foreign Application Priority Data
Aug. 23, 2017 (JP) 2017-159883

(51) Int. Cl. G06Q 30/02; G06N 20/00; G06N 5/02

(52) U.S. Cl. CPC G06Q 30/0202; G06N 5/02; G06N 20/00

(57) ABSTRACT

A predicting data generation unit 91 generates, on the basis of a prediction day, predicting data having added thereto a value of an explanatory variable indicating whether the day corresponds to a date predetermined as a day on which cash transfer will take place. A prediction device 92 predicts cash demand by applying the predicting data to a learned model, the learned model having prediction formulae determined depending on a value of an explanatory variable. The prediction device 92, in accordance with the value of the explanatory variable included in the predicting data, selects a prediction formula for use in the prediction from among the plurality of prediction formulae indicated by the learned model, and applies the predicting data to the selected prediction formula to predict the cash demand.

### TECHNICAL FIELD

The present invention relates to a cash demand prediction system, a cash demand prediction method, and a cash demand prediction program for predicting the cash demand.

### BACKGROUND ART

In recent years, automated teller machines (hereinafter, ATMs) have been installed not only in banks but also in convenience stores and other stores and in train stations from the standpoint of customers' convenience. While the ATM stores cash such as ten-thousand yen bills and thousand yen bills in its internal safe, the cash flows in and out in response to deposit and withdrawal transactions. It is therefore necessary to predict such inflow and outflow in accordance with the demands for cash and to store and collect the cash appropriately.

For example, Patent Literature (PTL) 1 describes an information processing apparatus which comprehensively plans replenishment and collection for a plurality of denominations of currency to reduce the cost required for the replenishment and collection. The information processing apparatus described in PTL 1 predicts the number of banknotes to be flown in or out in the future, on the basis of the number of banknotes flown in or out in the same month of the preceding year. Specifically, with respect to a target day, the information processing apparatus described in PTL 1 extracts, from transaction data for the same month of the previous year, the number of banknotes for each denomination present at the daily starts of business in the same month of the previous year. The apparatus then subtracts the number of banknotes present at the start of business of the day following the target day in the same month of the previous year from the number of banknotes present at the start of business of the target day in the same month of the previous year, and regards the obtained value as the number of banknotes to be flown in or out on the target day.

### CITATION LIST

### Patent Literature

PTL 1: Japanese Patent Application Laid-Open No. 2015-069263

### SUMMARY OF INVENTION

### Technical Problem

Cash replenishment and collection require certain costs, so further improvement in accuracy of the cash demand prediction is desired. It is conceivable, as described in PTL 1, that the tendency of the number of banknotes flown in or out on a target day may well resemble that of the number of banknotes flown in or out in the same month of the previous year, so the cash demand prediction may probably be made in accordance with such tendency. However, the information processing apparatus described in PTL 1 can predict only a rough tendency on a monthly basis, and finds difficulty in making a prediction taking account of the tendency specific to the target day.

On the other hand, the cash demands are considered to vary depending on the characteristics of the days on which cash transfer takes place. It is therefore preferable to change a prediction formula to be used, in accordance with the characteristics of the prediction day. However, if the contents of the prediction formulae to be changed are a black box, it will be difficult to verify the prediction process, and it will also be difficult to interpret the prediction result.

An object of the present invention is thus to provide a cash demand prediction system, a cash demand prediction method, and a cash demand prediction program capable of improving the interpretability of a cash demand prediction result.

### Solution to Problem

A cash demand prediction system according to the present invention includes: a predicting data generation unit configured to generate, on the basis of a prediction day, predicting data having added thereto a value of an explanatory variable indicating whether the day corresponds to a date predetermined as a day on which cash transfer will take place; and a prediction device configured to predict cash demand by applying the predicting data to a learned model, the learned model having prediction formulae determined depending on a value of an explanatory variable, wherein the prediction device, in accordance with the value of the explanatory variable included in the predicting data, selects a prediction formula for use in the prediction from among the plurality of prediction formulae indicated by the learned model, and applies the predicting data to the selected prediction formula to predict the cash demand.

A cash demand prediction method according to the present invention includes: generating, on the basis of a prediction day, predicting data having added thereto a value of an explanatory variable indicating whether the day corresponds to a date predetermined as a day on which cash transfer will take place; predicting cash demand by applying the predicting data to a learned model, the learned model having prediction formulae determined depending on a value of an explanatory variable; and upon the predicting, selecting, in accordance with the value of the explanatory variable included in the predicting data, a prediction formula for use in the prediction from among the plurality of prediction formulae indicated by the learned model, and applying the predicting data to the selected prediction formula to predict the cash demand.

A cash demand prediction program according to the present invention causes a computer to perform: predicting data generation processing of generating, on the basis of a prediction day, predicting data having added thereto a value of an explanatory variable indicating whether the day corresponds to a date predetermined as a day on which cash transfer will take place; and prediction processing of predicting cash demand by applying the predicting data to a learned model, the learned model having prediction formulae determined depending on a value of an explanatory variable; wherein the program causes the computer to perform, in the prediction processing, selecting, in accordance with the value of the explanatory variable included in the predicting data, a prediction formula for use in the prediction from among the plurality of prediction formulae indicated by the learned model, and applying the predicting data to the selected prediction formula to predict the cash demand.

### Advantageous Effects of Invention

The present invention is capable of improving the interpretability of the cash demand prediction result.

### BRIEF DESCRIPTION OF DRAWINGS

FIG. 1 is a block diagram showing an exemplary configuration of a first embodiment of a cash demand prediction system according to the present invention.

FIG. 2 is a diagram illustrating exemplary actual data.

FIG. 3 is a diagram illustrating an exemplary model having prediction formulae determined depending on the a value of an explanatory variable.

FIG. 4 is a diagram illustrating an example of the processing of generating predicting data.

FIG. 5 is a diagram illustrating exemplary prediction formulae selected.

FIG. 6 is a flowchart illustrating an exemplary operation of the cash demand prediction system.

FIG. 7 is a diagram illustrating another example of the processing of generating predicting data.

FIG. 8 is a block diagram showing an overview of the cash demand prediction system according to the present invention.

### DESCRIPTION OF EMBODIMENT

Embodiments of the present invention will be described below with reference to the drawings. In the following, a description will be given, by way of example, of the case where a target of cash demand prediction is an ATM. However, the cash demand prediction target is not limited to the ATM, and it may be, for example, an unattended store, or a store requiring security transportation of cash.

### Embodiment 1

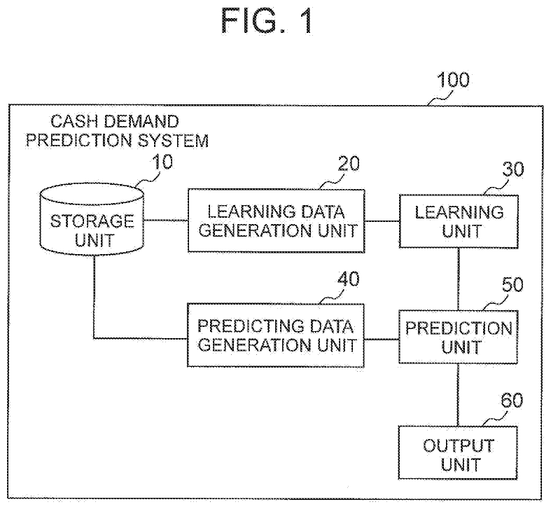

FIG. 1 is a block diagram showing an exemplary configuration of a first embodiment of a cash demand prediction system according to the present invention. The cash demand prediction system 100 of the present embodiment includes a storage unit 10, a learning data generation unit 20, a learning unit 30, a predicting data generation unit 40, a prediction unit 50, and an output unit 60.

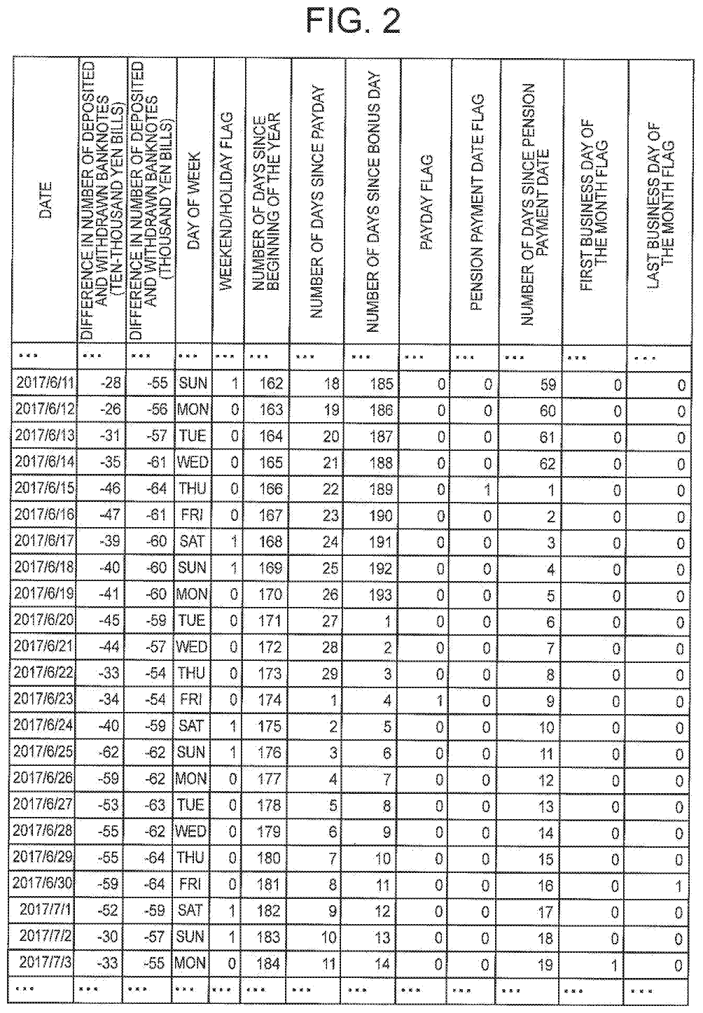

The storage unit 10 stores actual data on daily cash demands in the past. FIG. 2 is a diagram illustrating an example of the actual data. The actual data illustrated in FIG. 2 is actual data on a daily basis for a certain ATM. The data includes, not only the difference in number of deposited and withdrawn banknotes, but also information that can be acquired from a calendar (day of week, weekend/holiday flag, number of days since the beginning of the year).

The actual data in the present embodiment further includes a flag (hereinafter, referred to as “payday flag”) indicating whether the day is a payday, a flag (hereinafter, referred to as “pension payment date flag”) indicating whether the day is a pension payment date, the number of days since the payday, and the number of days since the pension payment date. Moreover, the actual data in the present embodiment includes a flag (hereinafter, referred to as “last business day of the month flag”) indicating whether the day is the last business day at the end of the month, and a flag (hereinafter, referred to as “first business day of the month flag”) indicating whether the day is the first business day at the beginning of the month. The actual data may further include other information such as the number of days since a bonus day, as illustrated in FIG. 2.

The learning data generation unit 20, on the basis of the actual data, generates learning data that the learning unit 30, which will be described later, uses for generating a model. The learning data generation unit 20 may generate a model (hereinafter, referred to as “learned model”) that uses the contents indicated in the columns of the table illustrated in FIG. 2, for example, as explanatory variables.

Further, when using past actual data (for example, the difference in number of deposited and withdrawn banknotes three month ago) as an explanatory variable, the learning data generation unit 20 may generate the learning data with the past actual data combined thereto. Further, the learning data generation unit 20 may generate, as an explanatory variable, aggregate data of past actual data (for example, data obtained by calculating an average over the past three months using the same day three month ago as the start point), and generate the learning data with the aggregate data combined thereto.

The learning unit 30 generates a learned model on the basis of the learning data generated by the learning data generation unit 20. In the present embodiment, the learning unit 30 generates a learned model that includes at least one or both of the above-described payday flag and pension payment date flag as the explanatory variables.

The contents of the learned model generated by the learning unit 30 are not particularly restricted. The learning unit 30 may generate, for example, a logistic regression model, a support vector machine (SVM) model, or the like.

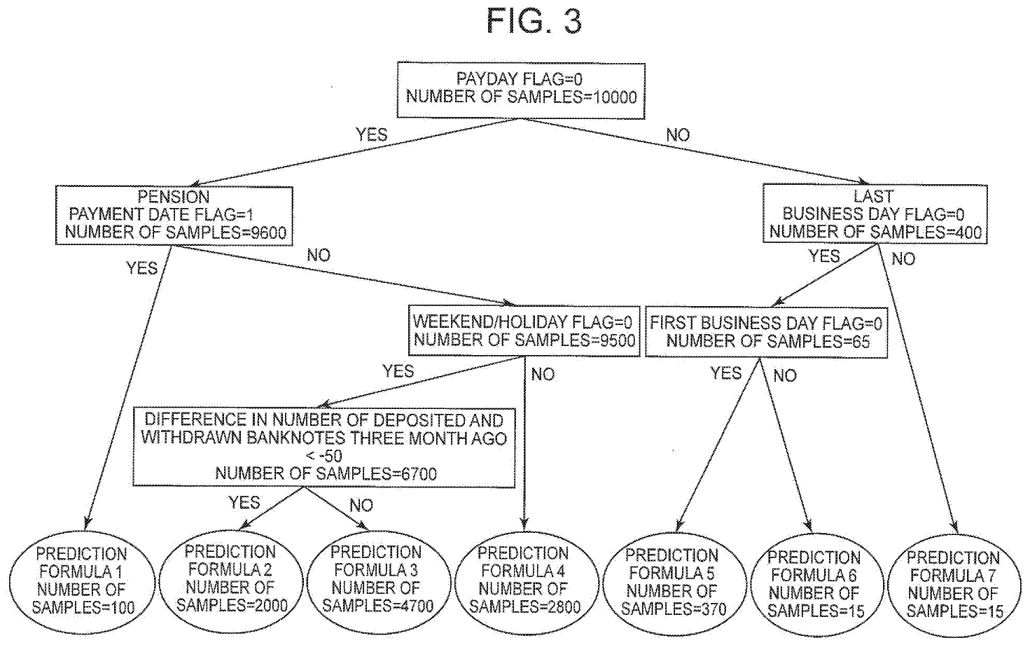

Further, from the standpoint of ease of interpretation of the model, the learning unit 30 may generate a learned model having prediction formulae determined depending on the a value of an explanatory variable. FIG. 3 is a diagram illustrating an example of the model in which prediction formulae selected are expressed in a tree structure and the prediction formulae are determined depending on the a value of an explanatory variable. The model illustrated in FIG. 3 has the prediction formulae arranged in respective leaf nodes, and the nodes branch in accordance with the values of the explanatory variables.

In the example shown in FIG. 3, firstly, possible prediction formulae are selected depending on whether the prediction day is a payday or not. Thereafter, for example when the prediction day is not a payday and the prediction day is a pension payment date, then the prediction formula 1 is selected. When the model illustrated in FIG. 3 is learned, the prediction unit 50, which will be described later, selects a prediction formula, on the basis of the prediction day for making a prediction and attributes of the prediction target, and makes a prediction.

The learning unit 30 may store the generated learned model in the storage unit 10. It should be noted that when a learned model has already been generated, the learning data generation unit 20 and the learning unit 30 may not be provided in the cash demand prediction system 100.

The predicting data generation unit 40 generates predicting data used for making a prediction by the prediction unit 50, which will be described later. Specifically, the predicting data generation unit 40 generates, on the basis of a prediction day, predicting data having added thereto a value of an explanatory variable indicating whether the day corresponds to a date predetermined as a day on which cash transfer will take place. At this time, the predicting data generation unit 40 generates the predicting data that includes the value of the explanatory variable included in the learned model.

As explained above, in the present embodiment, the learned model includes at least one or both of the above-described payday flag and pension payment date flag as the explanatory variables. Thus, the predicting data generation unit 40 determines the values of the payday flag and the pension payment date flag in accordance with the prediction day, and generates the predicting data having the determined values of the payday flag and the pension payment date flag added thereto.

It should be noted that the predicting data generation unit 40 may determine a value of only one of the payday flag and the pension payment date flag, and generate the predicting data having the determined value of the flag added thereto.

A way of setting a payday flag will now be described specifically. A payday is generally set on a certain day of each month. Thus, the predicting data generation unit 40 specifies a monthly payday. For example, a payday is often set on the 25th of every month, so the predicting data generation unit 40 may predetermine “25th” as the payday and specify the thus determined “25th” as the monthly payday.

It should be noted that the monthly payday may vary depending on the regions. Thus, the predicting data generation unit 40 may change the value of the monthly payday in accordance with the region where the cash demand prediction is to be made. Hereinafter, the day specified as the monthly payday by the predicting data generation unit 40 will be referred to as “prescribed payday”.

When the day of the prediction day corresponds to the prescribed payday, the predicting data generation unit 40 determines the value of the payday flag to a value (for example, “1”) indicating that it is the payday. When the day of the prediction day does not correspond to the prescribed payday, the predicting data generation unit 40 determines the value of the payday flag to a value (for example, “0”) indicating that it is not the payday. Here, that the day of the prediction day corresponds to the prescribed payday means that a portion of the prediction day excluding “month” and “year”, i.e. “day”, coincides with the prescribed payday.

However, when the prescribed payday falls on the weekend or holiday (specifically, Saturday, Sunday, or holiday), the day usually is not set as the payday. Thus, when the day of the prediction day corresponds to the prescribed payday and the prediction day falls on the weekend or holiday, the predicting data generation unit 40 determines the value of the payday flag to the value (for example, “0”) indicating that it is not the payday.

In this case, a weekday immediately preceding the prescribed payday is set as the payday. Thus, even in the case where the prediction day does not correspond to the prescribed payday, when the prescribed payday of that month indicated by the prediction day falls on the weekend or holiday and when the prediction day is the day that immediately precedes the prescribed payday of that month and does not fall on the weekend or holiday, then the predicting data generation unit 40 determines the value of the payday flag to the value (for example, “1”) indicating that it is the payday.

The predicting data generation unit 40 then generates the predicting data having the value of the payday flag determined on the basis of the prediction day added thereto.

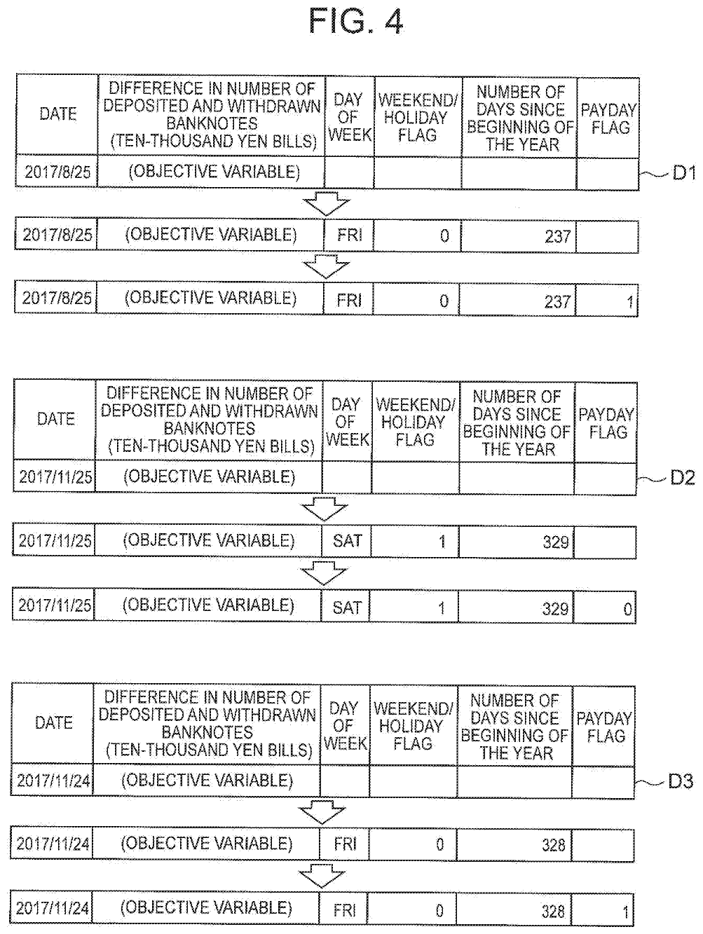

FIG. 4 is a diagram illustrating an example of the processing of generating predicting data. It is here assumed that the predicting data generation unit 40 generates predicting data in which the day of week, a weekend/holiday flag, the number of days since the beginning of the year, and a payday flag are set with respect to a prediction day for predicting the difference in number of deposited and withdrawn banknotes (ten-thousand yen bills). It should be noted that the prescribed payday is assumed to be “25th”.

It is first assumed that a prediction day D1 is “Aug. 25, 2017”. The day of week, the weekend/holiday flag, and the number of days since the beginning of the year illustrated in FIG. 4 can be obtained from calendar information. Thus, the predicting data generation unit 40 determines, for Aug. 25, 2017, the day of week, whether it falls on the weekend or holiday, and the number of days since the beginning of the year as “Friday”, “not falling on weekend or holiday”, and “237 days” on the basis of the calendar information.

Next, the predicting data generation unit 40 determines a value of the payday flag. “Aug. 25, 2017” corresponds to the prescribed payday and does not fall on the weekend or holiday, so the predicting data generation unit 40 determines that “Aug. 25, 2017” is the payday, and sets the value of the payday flag to “1”.

Next, it is assumed that a prediction day D2 is “Nov., 25, 2017”. As in the case of Aug. 25, 2017, the predicting data generation unit 40 determines, for Nov. 25, 2017, the day of week, whether it falls on the weekend or holiday, and the number of days since the beginning of the year as “Saturday”, “falling on weekend or holiday”, and “329 days” on the basis of the calendar information. Although “Nov. 25, 2017” corresponds to the prescribed payday, it falls on the weekend or holiday, so the predicting data generation unit 40 determines that “Nov. 25, 2017” is not the payday, and sets the value of the payday flag to “0”.

It is now assumed that a prediction day D3 is “Nov. 24, 2017”. As in the case of Aug. 25, 2017, the predicting data generation unit 40 determines, for Nov. 24, 2017, the day of week, whether it falls on the weekend or holiday, and the number of days since the beginning of the year as “Friday”, “not falling on weekend or holiday”, and “328 days” on the basis of the calendar information. While “Nov. 24, 2017” does not correspond to the prescribed payday, the prescribed payday of November falls on Saturday. Further, the 24th is a weekday immediately preceding the prescribed payday “25th”. Thus, the predicting data generation unit 40 determines that “Nov. 24, 2017” is the payday, and sets the value of the payday flag to “1”.

Next, a way of setting a pension payment date flag will be described specifically. The basic idea for a pension payment date is similar to that for a payday. Specifically, a pension is paid in even-numbered months, and the pension payment date is the 15th of the payment month. When the pension payment date falls on the weekend or holiday, the pension is paid on the immediately preceding weekday. Hereinafter, the payment date (here, “15th”) of the pension payment month will be referred to as “prescribed pension payment date”.

When the day of the prediction day corresponds to the prescribed pension payment date, the predicting data generation unit 40 determines a value of a pension payment date flag to a value (for example, “1”) indicating that it is the pension payment date. When the day of the prediction day does not correspond to the prescribed pension payment date, the predicting data generation unit 40 determines the value of the pension payment day flag to a value (for example, “0”) indicating that it is not the pension payment date. Here, that the day of the prediction day corresponds to the prescribed pension payment date means that a portion of the prediction day excluding “month” and “year”, i.e. “day”, coincides with the prescribed pension payment date.

When the month of the prediction day corresponds to the pension payment month and the day of the prediction day corresponds to the prescribed pension payment date, and when the prediction day falls on the weekend or holiday, then the predicting data generation unit 40 determines the value of the pension payment date flag to the value (for example, “0”) indicating that it is not the pension payment date. Further, even in the case where the month of the prediction day corresponds to the prescribed pension payment month and the day of the prediction day does not correspond to the prescribed pension payment date, when the prescribed pension payment date of that month indicated by the prediction day falls on the weekend or holiday and when the prediction day is the day that immediately precedes the prescribed pension payment date of that month and does not fall on the weekend or holiday, then the predicting data generation unit 40 determines the value of the pension payment date flag to the value (for example, “1”) indicating that it is the pension payment date.

The predicting data generation unit 40 then generates the predicting data having the value of the pension payment date flag determined on the basis of the prediction day added thereto.

The prediction unit 50 applies the predicting data to the learned model to predict the cash demand. In the present embodiment, the learned model includes one or both of the payday flag and the pension payment date flag as the explanatory variables. Thus, the prediction unit 50 predicts the cash demand by applying to the learned model the predicting data having the value of one or both of the payday flag and the pension payment date flag added thereto.

For example, when the learning unit 30 has generated a learned model having prediction formulae determined depending on the a value of an explanatory variable, the prediction unit 50 uses the learned model and selects a prediction formula for use in the prediction from among the plurality of prediction formulae, in accordance with the value(s) of the explanatory variable(s) included in the predicting data. The prediction unit 50 then applies the predicting data to the selected prediction formula to thereby prediction the cash demand.

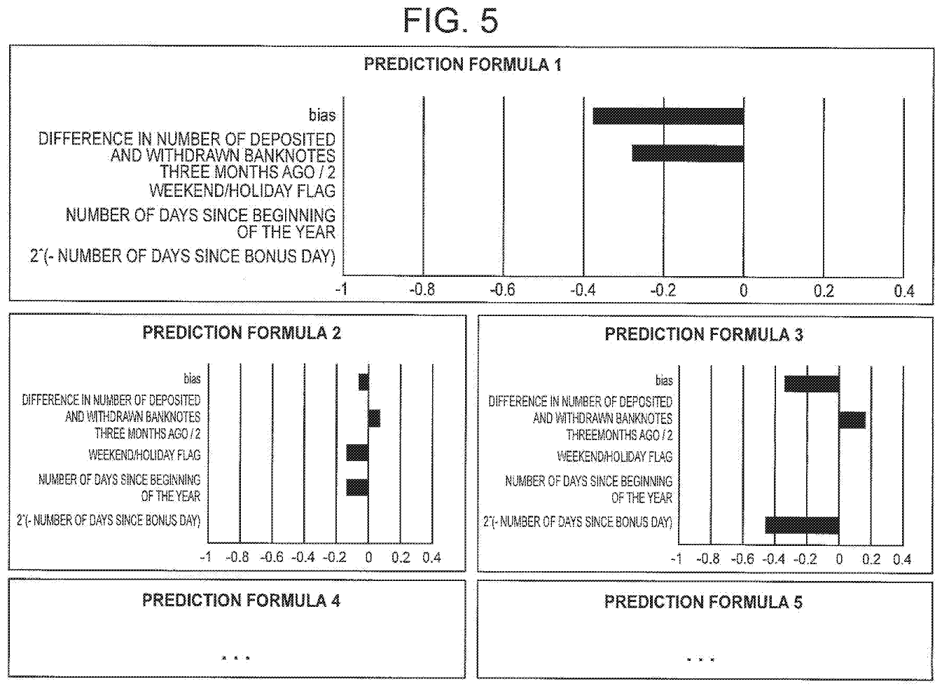

FIG. 5 is a diagram illustrating exemplary prediction formulae selected in the learned model illustrated in FIG. 3. The bar graphs (here, horizontal bar graphs) illustrated in FIG. 5 respectively indicate prediction formulae each expressed as a linear regression equation. Specifically, for each prediction formula, a description of an explanatory variable is indicated along one axis (here, on the left) of the graph, and a value of the corresponding horizontal bar represents a coefficient (weight) of the explanatory variable. For example, the prediction formula 1 illustrated in FIG. 5 indicates that the difference in number of deposited and withdrawn banknotes three month ago is used as an explanatory variable and that a bias has been added thereto. For example, the prediction formula 1 illustrated in FIG. 5 is similar to the expression 1 shown below. It should be noted that the graph may be a vertical bar graph.

Difference in number of deposited and withdrawn banknotes=−0.28×difference in number of deposited and withdrawn banknotes three month ago/2−0.38 (Expression 1)

The output unit 60 outputs a prediction result of the cash demand by the prediction unit 50. The output unit 60 may display the prediction result on a display device (not shown) or store the result in the storage unit 10. Further, the output unit 60 may output the prediction formulae expressed as the linear regression equations in the form of horizontal bar graphs as illustrated in FIG. 5. Displaying the prediction formulae as the list of graphs as illustrated in FIG. 5 facilitates recognizing at a glance the tendencies of cash demands attributable to the days when cash transfer will take place.

Further, as illustrated in FIG. 3, the output unit 60 may output, for each node of the generated learned model, the number of samples (the number of pieces of actual data) that pass the node when the actual data used during learning is applied to the learned model. Outputting such information enables understanding the ratio of use of each prediction formula.

The learning data generation unit 20, the learning unit 30, the predicting data generation unit 40, the prediction unit 50, and the output unit 60 are implemented by a processor (for example, central processing unit (CPU), graphics processing unit (GPU), field-programmable gate array (FPGA)) of a computer that operates in accordance with a program (cash demand prediction program).

For example, the program may be stored in the storage unit 10, and the processor may read the program and operate as the learning data generation unit 20, the learning unit 30, the predicting data generation unit 40, the prediction unit 50, and the output unit 60 in accordance with the program. Further, the functions of the cash demand prediction system may be provided in the form of Software as a Service (SaaS).

The learning data generation unit 20, the learning unit 30, the predicting data generation unit 40, the prediction unit 50, and the output unit 60 may each be implemented by dedicated hardware. Further, some or all of the constituent components of the devices may be implemented by general-purpose or dedicated circuitry, processor, or any combination thereof. They may be configured by a single chip, or by a plurality of chips connected via a bus. Some or all of the constituent components of the devices may be implemented by a combination of the above-described circuitry or the like and the program.

Further, in the case where some or all of the constituent components of the devices are implemented by a plurality of information processing devices or circuits, such information processing devices or circuits may be arranged in a centralized or distributed manner. For example, the information processing devices or circuits may be implemented in the form of a client and server system, a cloud computing system, or the like in which they are connected via a communication network.

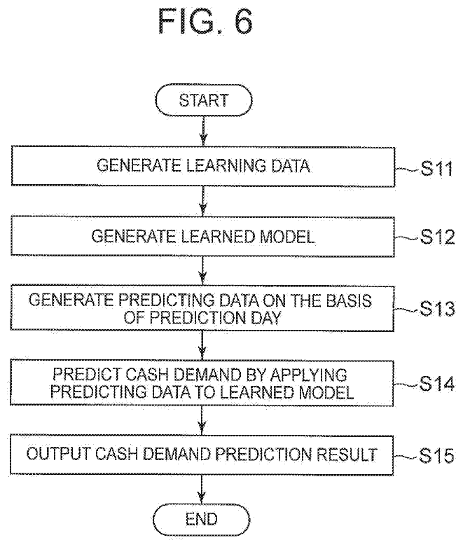

An operation of the cash demand prediction system of the present embodiment will now be described. FIG. 6 is a flowchart illustrating an exemplary operation of the cash demand prediction system of the present embodiment.

The learning data generation unit 20 generates learning data on the basis of actual data (step S11), and the learning unit 30 generates a learned model on the basis of the generated learning data (step S12).

The predicting data generation unit 40 generates, on the basis of a prediction day, predicting data having added thereto a value of an explanatory variable indicating whether the day corresponds to a date predetermined as a day on which cash transfer will take place (step S13). In the present embodiment, the predicting data generation unit 40 determines a value of one or both of a payday flag and a pension payment date flag, on the basis of the prediction day, and generates the predicting data having the determined value(s) added thereto.

The prediction unit 50 predicts cash demand by applying the predicting data, with the value of one or both of the payday flag and the pension payment date flag added thereto, to the learned model (step S14). For example, in the case where a learned model having prediction formulae determined depending on the value of the explanatory variable is used, the prediction unit 50 selects a prediction formula for use in the prediction from among the plurality of prediction formulae, in accordance with the value(s) of the explanatory variable(s) included in the predicting data, and applies the predicting data to the selected prediction formula to predict the cash demand. The output unit 60 then outputs the cash demand prediction result (step S15).

As described above, in the present embodiment, the predicting data generation unit 40 generates predicting data on the basis of a prediction day, the predicting data having added thereto a value of an explanatory variable indicating whether the day corresponds to a date predetermined as a day on which cash transfer will take place. Specifically, the predicting data generation unit 40 determines a value of one or both of a payday flag and a pension payment date flag on the basis of the prediction day, and generates the predicting data having the determined value(s) added thereto. The prediction unit 50 then predicts the cash demand by applying to a learned model the predicting data having a value of one or both of the payday flag and the pension payment date flag added thereto.

Such a configuration improves the accuracy of the cash demand prediction. That is, in the present embodiment, the cash demand is prediction taking account of the payday and/or the pension payment date on which cash becomes available. This enables making a prediction in consideration of the tendency specific to the prediction day.

Further, in the present embodiment, the predicting data generation unit 40 generates, on the basis of the prediction day, the predicting data having added thereto a value of the explanatory variable indicating whether the day corresponds to the date predetermined as a day on which cash transfer will take place. The prediction unit 50 then predicts the cash demand by applying the predicting data to a learned model having prediction formulae determined depending on a value of an explanatory variable. Specifically, the prediction unit 50, in accordance with the value of the explanatory variable included in the predicting data, selects a prediction formula for use in the prediction from among the plurality of prediction formulae indicated by the learned model, and applies the predicting data to the selected prediction formula to predict the cash demand.

Such a configuration improves the interpretability of the cash demand prediction result. Specifically, it facilitates understanding the tendencies of cash demands that vary in accordance with the characteristics of the days on which cash transfer will take place.

### Embodiment 2

A second embodiment of the cash demand prediction system according to the present invention will now be described. In the first embodiment, the description was given of the case where the cash demand prediction system generates a learned model including one or both of the payday flag and the pension payment date flag as the explanatory variables. The present embodiment focuses on the business days in each month as the days on which cash transfer will take place.

The configuration of the cash demand prediction system in the present embodiment is similar to that in the first embodiment. However, in the present embodiment, the learning unit 30 generates a learned model that includes one or both of a last business day of the month flag and a first business day of the month flag as explanatory variables. Therefore, the storage unit 10 stores actual data including the last business day of the month flag and the first business day of the month flag. It should be noted that the manner for the learning unit 30 to generate the learned model is similar to that in the first embodiment. That is, the learning unit 30 may generate a learned model having prediction formulae determined depending on the a value of an explanatory variable.

The predicting data generation unit 40 generates predicting data on the basis of a prediction day. In the present embodiment, the learned model includes at least one or both of the above-described last business day of the month flag and first business day of the month flag as the explanatory variables. Thus, the predicting data generation unit 40 determines the values of the last business day of the month flag and the first business day of the month flag on the basis of the prediction day, and generates the predicting data having the determined values of the last business day of the month flag and the first business day of the month flag added thereto.

It should be noted that the predicting data generation unit 40 may determine a value of only one of the last business day of the month flag and the first business day of the month flag, and generate the predicting data having the determined value of the flag added thereto.

A way of setting the last business day of the month flag will now be described specifically. The last business day at the end of the month (specifically, 28th, 29th, 30th, or 31st) is generally set on the last weekday of the month. Thus, when the prediction day corresponds to the last day at the end of the month and does not fall on any of the weekend, holiday, and year-end and new-year holidays, the predicting data generation unit 40 determines the value of the last business day of the month flag to a value (for example, “1”) indicating that it is the last business day at the end of the month. When the prediction day does not correspond to the last day at the end of the month, the predicting data generation unit 40 determines the value of the last business day of the month flag to a value (for example, “0”) indicating that it is not the last business day at the end of the month. On the other hand, when the prediction day corresponds to the last day at the end of the month and falls on any of the weekend, holiday, and year-end and new-year holidays, then the predicting data generation unit 40 determines the value of the last business day of the month flag to the value (for example, “0”) indicating that it is not the last business day at the end of the month.

Here, the year-end and new-year holidays are generally set to from December 29 to January 3. However, the year-end and new-year holidays are not limited to the above period, and may be determined to any given period during which business is practically suspended.

Further, even in the case where the prediction day does not correspond to the last day at the end of the month, when the last day of that month indicated by the prediction day falls on any of the weekend, holiday, and year-end and new-year holidays and when the prediction day is the day that immediately precedes the last day at the end of that month and does not fall on any of the weekend, holiday, and year-end and new-year holidays, then the predicting data generation unit 40 determines the value of the last business day of the month flag to the value (for example, “1”) indicating that it is the last business day at the end of the month.

The predicting data generation unit 40 then generates the predicting data having the value of the last business day of the month flag determined on the basis of the prediction day added thereto.

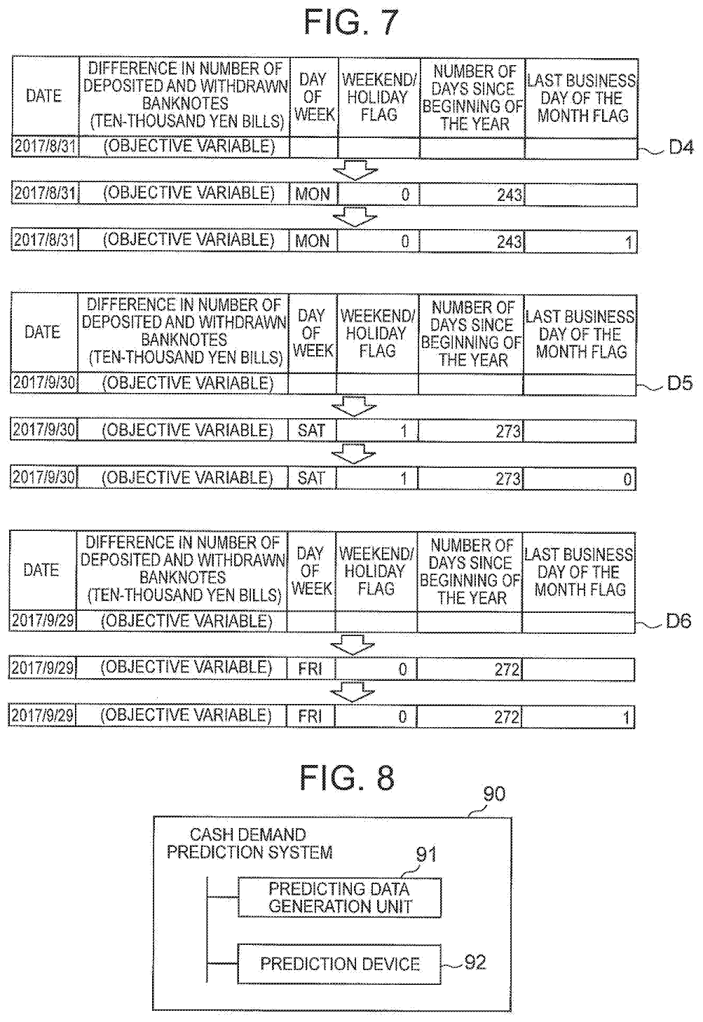

FIG. 7 is a diagram illustrating another example of the processing of generating predicting data. It is here assumed that the predicting data generation unit 40 generates predicting data in which the day of week, a weekend/holiday flag, the number of days since the beginning of the year, and a last business day of the month flag are set with respect to a prediction day for predicting the difference in number of deposited and withdrawn banknotes (ten-thousand yen bills).

It is first assumed that a prediction day D4 is “Aug. 31, 2017”. The day of week, the weekend/holiday flag, and the number of days since the beginning of the year illustrated in FIG. 7 can be obtained from calendar information. Thus, the predicting data generation unit 40 determines, for Aug. 31, 2017, the day of week, whether it falls on the weekend or holiday, and the number of days since the beginning of the year as “Monday”, “not falling on weekend or holiday”, and “243 days” on the basis of the calendar information.

Next, the predicting data generation unit 40 determines a value of the last business day of the month flag. “Aug. 31, 2017” corresponds to the last day (31st) at the end of the month and does not fall on the weekend or holiday, so the predicting data generation unit 40 determines that “Aug. 31, 2017” is the last business day at the end of the month, and sets the value of the last business day of the month flag to “1”.

Next, it is assumed that a prediction day D5 is “Sep. 30, 2017”. As in the case of Aug. 31, 2017, the predicting data generation unit 40 determines, for Sep. 30, 2017, the day of week, whether it falls on the weekend or holiday, and the number of days since the beginning of the year as “Saturday”, “falling on weekend or holiday”, and “273 days” on the basis of the calendar information. While “Sep. 30, 2017” corresponds to the last day (30th) at the end of the month, it falls on the weekend or holiday, so the predicting data generation unit 40 determines that “Sep. 30, 2017” is not the last business day at the end of the month, and sets the value of the last business day of the month flag to “0”.

It is now assumed that a prediction day D6 is “Sep. 29, 2017”. As in the case of Aug. 31, 2017, the predicting data generation unit 40 determines, for Sep. 29, 2017, the day of week, whether it falls on the weekend or holiday, and the number of days since the beginning of the year as “Friday”, “not falling on weekend or holiday”, and “272 days” on the basis of the calendar information. “Sep. 29, 2017” does not correspond to the last day at the end of the month. However, the last day at the end of September falls on Saturday. Further, the 29th is a weekday that immediately precedes the last day “30th” at the end of September. Thus, the predicting data generation unit 40 determines that “Sep. 29, 2017” is the last business day at the end of the month, and sets the value of the last business day of the month flag to “1”.

Next, a way of setting a first business day of the month flag will be described specifically. The basic idea for the first business day at the beginning of the month is similar to that for the last business day at the end of the month. Specifically, the first business day at the beginning of the month is generally set on the first weekday of the month. Thus, when the prediction day corresponds to the first day (1st) of the month and does not fall on any of the weekend, holiday, and year-end and new-year holidays, the predicting data generation unit 40 determines the value of the first business day of the month flag to a value (for example, “1”) indicating that it is the first business day at the beginning of the month. When the prediction day does not correspond to the first day (1st) of the month, the predicting data generation unit 40 determines the value of the first business day of the month flag to a value (for example, “0”) indicating that it is not the first business day at the beginning of the month. On the other hand, when the prediction day corresponds to the first day of the month and falls on any of the weekend, holiday, and year-end and new-year holidays, then the predicting data generation unit 40 determines the value of the first business day of the month flag to the value (for example, “0”) indicating that it is not the first business day at the beginning of the month.

Further, even in the case where the prediction day does not correspond to the first day of the month, when the first day of that month indicated by the prediction day falls on any of the weekend, holiday, and year-end and new-year holidays and when the prediction day is the day that immediately follows the first day of that month and does not fall on any of the weekend, holiday, and year-end and new-year holidays, then the predicting data generation unit 40 determines the value of the first business day of the month flag to the value (for example, “1”) indicating that it is the first business day at the beginning of the month.

The predicting data generation unit 40 then generates the predicting data having the value of the first business day of the month flag determined on the basis of the prediction day added thereto.

The prediction unit 50 applies the predicting data to the learned model to predict the cash demand. In the present embodiment, the learned model includes one or both of the last business day of the month flag and the first business day of the month flag as the explanatory variables. Thus, the prediction unit 50 predicts the cash demand by applying to the learned model the predicting data having the value of one or both of the last business day of the month flag and the first business day of the month flag added thereto.

It should be noted that the model used by the prediction unit 50 in the present embodiment may be a learned model having prediction formulae determined depending on the value of an explanatory variable, as explained in conjunction with the first embodiment. Further, as in the case of the first embodiment, the output unit 60 may store the prediction result in the storage unit 10 or may display the result on a display device (not shown) as illustrated in FIG. 5.

An operation of the cash demand prediction system in the present embodiment will now be described. The operation of the cash demand prediction system in the present embodiment is similar to the operation shown by the flowchart illustrated in FIG. 6. However, in the present embodiment, the predicting data generation unit 40 determines a value of one or both of the last business day of the month flag and the first business day of the month flag on the basis of a prediction day, and generates predicting data having the determined value(s) added thereto.

As described above, in the present embodiment, the predicting data generation unit 40 generates, on the basis of a prediction day, predicting data having added thereto a value of an explanatory variable indicating whether the day corresponds to a date predetermined as a day on which cash transfer will take place. Specifically, the predicting data generation unit 40 determines a value of one or both of the last business day of the month flag and the first business day of the month flag on the basis of the prediction day, and generates the predicting data having the determined value(s) added thereto. The prediction unit 50 then predicts the cash demand by applying to the learned model the predicting data having added thereto the value of one or both of the last business day of the month flag and the first business day of the month flag.

Such a configuration improves the accuracy of the cash demand prediction. That is, in the present embodiment, the cash demand is prediction taking account of the last business day at the end of the month on which cash reservation will be completed and the first business day at the beginning of the month on which cash will be required in large volume. This enables making a prediction in consideration of the tendency specific to the prediction day.

It should be noted that the description was given in the above of the case where the learning unit 30 in the first embodiment generates a learned model including one or both of the payday flag and the pension payment date flag as the explanatory variables, and the learning unit 30 in the second embodiment generates a learned model including one or both of the last business day of the month flag and the first business day of the month flag as the explanatory variables. In both embodiments, the learning unit 30 may generate a learned model that includes any of the payday flag, the pension payment date flag, the last business day of the month flag, and the first business day of the month flag.

In this case, the predicting data generation unit 40 may determine the value of the payday flag, the pension payment date flag, the last business day of the month flag, or the first business day of the month flag on the basis of the prediction day, and generate the predicting data having the determined value added thereto.

An overview of the present invention will now be described. FIG. 8 is a block diagram showing an overview of the cash demand prediction system according to the present invention. The cash demand prediction system 90 according to the present invention includes a predicting data generation unit 91 (for example, the predicting data generation unit 40) that generates, on the basis of a prediction day, predicting data having added thereto a value of an explanatory variable indicating whether the day corresponds to a date predetermined as a day on which cash transfer will take place, and a prediction device 92 (for example, the prediction unit 50) that predicts cash demand by applying the predicting data to a learned model having prediction formulae determined depending on a value of an explanatory variable.

The prediction device 92, in accordance with the value of the explanatory variable included in the predicting data, selects a prediction formula for use in the prediction from among the plurality of prediction formulae indicated by the learned model, and applies the predicting data to the selected prediction formula to predict the cash demand.

Such a configuration improves the interpretability of the cash demand prediction result.

The cash demand prediction system 90 may further include an output unit (for example, the output unit 60) that outputs the prediction formulae that can be selected, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.

Further, the output unit may output, for each node of the generated learned model, the number of pieces of actual data that pass the node when the actual data is applied to the learned model.

Further, the predicting data generation unit 91 may generate the predicting data having a value of a payday flag indicating whether it is a payday added thereto as a value of the explanatory variable indicating the day on which cash transfer will take place.

At this time, the predicting data generation unit 91 may determine the value of the payday flag to a value (for example, “1”) indicating that it is the payday when the prediction day corresponds to a prescribed payday (for example, “25th”) which is a date predetermined as a monthly payday, and the unit may determine the value of the payday flag to a value (for example, “0”) indicating that it is not the payday when the prediction day does not correspond to the prescribed payday.

Further, the predicting data generation unit 91 may generate the predicting data having a value of a pension payment date flag indicating whether it is a pension payment date added thereto as a value of the explanatory variable indicating the day on which cash transfer will take place.

Further, the predicting data generation unit 91 may generate the predicting data having a value of a last business day of the month flag indicating whether it is a last business day at the end of the month added thereto as a value of the explanatory variable indicating the day on which cash transfer will take place.

Further, the predicting data generation unit may generate the predicting data having a value of a first business day of the month flag indicating whether it is a first business day at the beginning of the month added thereto as a value of the explanatory variable indicating the day on which cash transfer will take place.

A part of or all of the above embodiments may also be described as, but not limited to, the following supplementary notes.

(Supplementary note 1) A cash demand prediction system comprising: a predicting data generation unit configured to generate, on the basis of a prediction day, predicting data having added thereto a value of an explanatory variable indicating whether the day corresponds to a date predetermined as a day on which cash transfer will take place; and a prediction device configured to predict cash demand by applying the predicting data to a learned model, the learned model having prediction formulae determined depending on a value of an explanatory variable, wherein the prediction device, in accordance with the value of the explanatory variable included in the predicting data, selects a prediction formula for use in the prediction from among the plurality of prediction formulae indicated by the learned model, and applies the predicting data to the selected prediction formula to predict the cash demand.

(Supplementary note 2) The cash demand prediction system according to Supplementary note 1, comprising an output unit configured to output the prediction formulae that can be selected, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.

(Supplementary note 3) The cash demand prediction system according to supplementary note 2, wherein the output unit outputs, for each node of the generated learned model, the number of pieces of actual data that pass the node when the actual data is applied to the learned model.

(Supplementary note 4) The cash demand prediction system according to any one of supplementary notes 1 to 3, wherein the predicting data generation unit generates the predicting data having a value of a payday flag indicating whether it is a payday added thereto as a value of the explanatory variable indicating the day on which cash transfer will take place.

(Supplementary note 5) The cash demand prediction system according to supplementary note 4, wherein the predicting data generation unit determines the value of the payday flag to a value indicating that it is the payday when the prediction day corresponds to a prescribed payday which is a date predetermined as a monthly payday, and the unit determines the value of the payday flag to a value indicating that it is not the payday when the prediction day does not correspond to the prescribed payday.

(Supplementary note 6) The cash demand prediction system according to any one of supplementary notes 1 to 5, wherein the predicting data generation unit generates the predicting data having a value of a pension payment date flag indicating whether it is a pension payment date added thereto as a value of the explanatory variable indicating the day on which cash transfer will take place.

(Supplementary note 7) The cash demand prediction system according to any one of supplementary notes 1 to 6, wherein the predicting data generation unit generates the predicting data having a value of a last business day of the month flag indicating whether it is a last business day at the end of the month added thereto as a value of the explanatory variable indicating the day on which cash transfer will take place.

(Supplementary note 8) The cash demand prediction system according to any one of supplementary notes 1 to 7, wherein the predicting data generation unit generates the predicting data having a value of a first business day of the month flag indicating whether it is a first business day at the beginning of the month added thereto as a value of the explanatory variable indicating the day on which cash transfer will take place.

(Supplementary note 9) A cash demand prediction method comprising: generating, on the basis of a prediction day, predicting data having added thereto a value of an explanatory variable indicating whether the day corresponds to a date predetermined as a day on which cash transfer will take place; predicting cash demand by applying the predicting data to a learned model, the learned model having prediction formulae determined depending on a value of an explanatory variable; and, upon the predicting, selecting, in accordance with the value of the explanatory variable included in the predicting data, a prediction formula for use in the prediction from among the plurality of prediction formulae indicated by the learned model, and applying the predicting data to the selected prediction formula to predict the cash demand.

(Supplementary note 10) The cash demand prediction method according to supplementary note 9, comprising outputting the prediction formulae that can be selected, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.

(Supplementary note 11) A cash demand prediction program causing a computer to perform: predicting data generation processing of generating, on the basis of a prediction day, predicting data having added thereto a value of an explanatory variable indicating whether the day corresponds to a date predetermined as a day on which cash transfer will take place; and prediction processing of predicting cash demand by applying the predicting data to a learned model, the learned model having prediction formulae determined depending on a value of an explanatory variable; wherein the program causes the computer to perform, in the prediction processing, selecting, in accordance with the value of the explanatory variable included in the predicting data, a prediction formula for use in the prediction from among the plurality of prediction formulae indicated by the learned model, and applying the predicting data to the selected prediction formula to predict the cash demand.

(Supplementary note 12) The cash demand prediction program according to supplementary note 11, causing the computer to perform: output processing of outputting the prediction formulae that can be selected, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.

While the present invention has been described with reference to the embodiment and examples, the present invention is not limited to the embodiment or examples above. The configurations and details of the present invention can be subjected to various modifications appreciable by those skilled in the art within the scope of the present invention.

This application claims priority based on Japanese Patent Application No. 2017-159883 filed on Aug. 23, 2017, the disclosure of which is incorporated herein in its entirety.

### REFERENCE SIGNS LIST

10 storage unit

20 learning data generation unit

30 learning unit

40 predicting data generation unit

50 prediction unit

60 output unit

100 cash demand prediction system

1. A cash demand prediction system comprising a hardware processor configured to execute a software code to:
generate, on the basis of a prediction day, predicting data having added thereto a value of an explanatory variable indicating whether the day corresponds to a date predetermined as a day on which cash transfer will take place; and
predict cash demand by applying the predicting data to a learned model, the learned model having prediction formulae determined depending on a value of an explanatory variable,
wherein the hardware processor is configured to execute a software code to, in accordance with the value of the explanatory variable included in the predicting data, select a prediction formula for use in the prediction from among the plurality of prediction formulae indicated by the learned model, and apply the predicting data to the selected prediction formula to predict the cash demand.

2. The cash demand prediction system according to claim 1, wherein the hardware processor is configured to execute a software code to output the prediction formulae that can be selected, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.

3. The cash demand prediction system according to claim 2, wherein the hardware processor is configured to execute a software code to output, for each node of the generated learned model, the number of pieces of actual data that pass the node when the actual data is applied to the learned model.

4. The cash demand prediction system according to claim 1, wherein the hardware processor is configured to execute a software code to generate the predicting data having a value of a payday flag indicating whether it is a payday added thereto as a value of the explanatory variable indicating the day on which cash transfer will take place.

5. The cash demand prediction system according to claim 4, wherein the hardware processor is configured to execute a software code to determine the value of the payday flag to a value indicating that it is the payday when the prediction day corresponds to a prescribed payday which is a date predetermined as a monthly payday, and determine the value of the payday flag to a value indicating that it is not the payday when the prediction day does not correspond to the prescribed payday.

6. The cash demand prediction system according to claim 1, wherein the hardware processor is configured to execute a software code to generate the predicting data having a value of a pension payment date flag indicating whether it is a pension payment date added thereto as a value of the explanatory variable indicating the day on which cash transfer will take place.

7. The cash demand prediction system according to claim 1, wherein the hardware processor is configured to execute a software code to generate the predicting data having a value of a last business day of the month flag indicating whether it is a last business day at the end of the month added thereto as a value of the explanatory variable indicating the day on which cash transfer will take place.

8. The cash demand prediction system according to claim 1, wherein the hardware processor is configured to execute a software code to generate the predicting data having a value of a first business day of the month flag indicating whether it is a first business day at the beginning of the month added thereto as a value of the explanatory variable indicating the day on which cash transfer will take place.

9. A cash demand prediction method comprising:
generating, on the basis of a prediction day, predicting data having added thereto a value of an explanatory variable indicating whether the day corresponds to a date predetermined as a day on which cash transfer will take place;
predicting cash demand by applying the predicting data to a learned model, the learned model having prediction formulae determined depending on a value of an explanatory variable; and
upon the predicting, selecting, in accordance with the value of the explanatory variable included in the predicting data, a prediction formula for use in the prediction from among the plurality of prediction formulae indicated by the learned model, and applying the predicting data to the selected prediction formula to predict the cash demand.

10. The cash demand prediction method according to claim 9, comprising outputting the prediction formulae that can be selected, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.

11. A non-transitory computer readable information recording medium storing a cash demand prediction program, when executed by a processor, that performs a method for:
generating, on the basis of a prediction day, predicting data having added thereto a value of an explanatory variable indicating whether the day corresponds to a date predetermined as a day on which cash transfer will take place; and
predicting cash demand by applying the predicting data to a learned model, the learned model having prediction formulae determined depending on a value of an explanatory variable;
wherein,
in accordance with the value of the explanatory variable included in the predicting data, a prediction formula for use in the prediction is selected from among the plurality of prediction formulae indicated by the learned model, and the predicting data is applied to the selected prediction formula to predict the cash demand.

12. The non-transitory computer readable information recording medium according to claim 11,
the prediction formulae that can be selected is output, in such a manner that, with each prediction formula being expressed as a linear regression equation, a bar graph representing the prediction formula has one axis along which a description of an explanatory variable is arranged, and a value of a bar corresponding to the explanatory variable represents a coefficient of the explanatory variable.
